(19) United States
(12) Patent Application Publication
(10) Pub. No.: US 2017/0149666 A1
(43) Pub. Date: May 25, 2017

(54) DATA TRAFFIC OPTIMIZATION SYSTEM

(71) Applicant: Titan Photonics, Inc., Fremont, CA (US)

(72) Inventors: Serdar Kiykioglu, Plano, TX (US); Gregory S. Gum, Pleasanton, CA (US)

(73) Assignee: Titan Photonics, Inc., Fremont, CA (US)

(21) Appl. No.: 15/358,692

(22) Filed: Nov. 22, 2016

Related U.S. Application Data
(60) Provisional application No. 62/258,549, filed on Nov. 23, 2015.

(51) Int. Cl. H04L 12/801; H04L 12/26; H04L 12/851

(52) U.S. Cl. CPC H04L 47/12; H04L 47/2441; H04L 43/0829; H04L 43/062

(57) ABSTRACT

A real-time data traffic optimization system is provided. The data traffic optimization system is configured to optimize data traffic between ingress and egress directions and includes a data traffic handler; a congestion window handler; and a controller block for coordinating the data traffic and data attributes in between the data traffic handler and the congestion window handler. The data optimization system further comprises a classifier for detecting and classifying incoming data traffic; a data monitor for monitoring and manipulating data attributes; and an adjuster for increasing and decreasing data congestion and adjusting the data transmitting and retransmitting time frame. The real-time data traffic optimization system can be embedded within a pluggable transceiver or an active optical cable.

### RELATED APPLICATIONS

The present application claims priority under 35 U.S.C. §119(e) to U.S. Provisional Application 62/258,549, titled “DATA TRAFFIC OPTIMIZATION SYSTEM,” filed on Nov. 23, 2015, which is hereby incorporated herein by reference in its entirety.

### TECHNICAL FIELD

This disclosure generally relates to computer networking and, more specifically, to devices that support network communication infrastructure.

### BACKGROUND

Computing devices, such as desktop computers, tablets, and smart phones, often compete for network resources. For example, devices connected to a network may concurrently execute a variety of processes that access local file shares, receive remotely broadcast multimedia data streams, and exchange data with one or more email servers. Each of these processes consumes a portion of the network's capacity by transmitting and receiving data via the network, and, where consumption outweighs the network's capacity, execution of the processes may degrade.

To combat the scarcity of network resources described above, some networks include devices designed to efficiently utilize the network's resources. For instance, computing devices that originate data transmitted on the network may implement congestion handling algorithms that manage the amount of data they transmit via the network within a given period of time. Using these algorithms, devices connected to the network collaborate to increase data throughput, and thereby help maintaining an acceptable level of service for all connected devices.

### SUMMARY

Data traffic optimization systems described herein monitor network conditions and dynamically manage congestion control within a network. In at least one example, a data traffic optimization system includes at least one ingress data connector configured to communicatively couple to a network interface and to receive inbound data from the network interface; at least one egress data connector configured to communicatively couple to the network interface and to transmit outbound data to the network interface; control circuitry coupled to the at least one ingress data connector and the at least one egress data connector; a data traffic handler at least one of executable and controllable by the control circuitry and configured to receive the inbound data via the at least one ingress data connector and to generate, based on the inbound data, at least one classification of at least one data path traversing the network interface, the at least one classification indicating that data traffic in the data path is at least one of latency sensitive video, latency sensitive audio, and latency insensitive data; a congestion window handler at least one of executable and controllable by the control circuitry and configured to control, based on at least one parameter, transmission of the outbound data via the at least one egress data connector; and a controller block at least one of executable and controllable by the control circuitry and configured to receive the at least one classification from the data traffic handler, to identify the at least one parameter based on the at least one classification, and to output the at least one parameter to the congestion window handler.

In the data traffic optimization system, the at least one data path may support a transmission control protocol connection including the data traffic. The data traffic handler may include a performance monitor configured to determine at least one characteristic of the at least one data path and a traffic classifier configured to identify the at least one classification based on the at least one characteristic. The at least one characteristic may include at least one of a measurement of latency of the at least one data path and a measurement of bandwidth of a network supporting the at least one data path. The measurement of bandwidth may be based on a number of packets dropped from the data path. The controller block may be configured to identify the at least one parameter within a cross-reference listing one or more classifications corresponding to one or more parameters. The at least one parameter may include at least one of a maximum congestion window and congestion window adjustment amount.

In the data traffic optimization system, the control circuitry may include local control circuitry and remote control circuitry distinct from the local control circuitry. The remote control circuitry may be configured to communicate with the local control circuitry via the network interface. The data traffic handler may be at least one of executable and controllable by the local control circuitry and may be further configured to transmit the at least one classification to the controller block via the network interface. The congestion window handler may be at least one of executable and controllable by the local control circuitry. The controller block may be at least one of executable and controllable by the remote control circuitry and may be further configured to transmit the at least one parameter to the congestion window handler via a remote network interface coupled to the remote control circuitry. The the congestion window handler may be configured to assign at least one default value to the at least one parameter prior to transmitting the at least one classification to the controller block.

In the data traffic optimization system, the controller block may be further configured to receive at least one override value for the at least one parameter; change at least one value of the at least one parameter to the at least one override value; and output the at least one parameter to the congestion window handler. The at least one ingress data connector comprises a plurality of ingress data connectors and the at least one egress data connector comprises a plurality of egress data connectors.

The control circuitry may include at least one processor and at least one data storage medium storing executable instructions encoded to instruct the at least one processor to implement the data traffic handler, the congestion window handler, and the controller block. The executable instructions may be encoded to instruct the at least one processor to implement at least one virtual data traffic optimization system including a plurality of virtual data traffic handlers including the data traffic handler, a plurality of virtual congestion window handlers including the congestion window handler, and a plurality of virtual controller blocks including the controller block.

The control circuitry may include purpose built circuitry. The purpose built circuitry may include at least one of an application specific integrated circuit (ASIC), a field programmable gate array (FPGA), and discrete circuitry. The control circuitry may include a plurality of purpose built circuits. The data traffic handler may be implemented as a first purpose built circuit of the plurality of purpose built circuits. The congestion window handler may be implemented as a second purpose built circuit of the plurality of purpose built circuits. The controller block may be implemented as a third purpose built circuit of the plurality of purpose built circuits.

In another example, a method of processing data traffic by a data traffic optimization system is provided. The method includes acts of receiving inbound data via at least one ingress data connector; generating, based on the inbound data, at least one classification of at least one data path on a network, the at least one classification indicating that data traffic in the data path is at least one of latency sensitive video, latency sensitive audio, and latency insensitive data; identifying at least one parameter based on the at least one classification; and controlling, based on the at least one parameter, transmission of outbound data via at least one egress data connector.

The method may further include acts of determining at least one characteristic of the at least one data path and identifying the at least one classification based on the at least one characteristic. The act of determining the at least one characteristic may include an act of calculating at least one of a measurement of latency of the at least one data path and a measurement of bandwidth of the network supporting the at least one data path. The act of calculating the measurement of bandwidth may include an act of identifying a number of packets dropped from the data path.

In another example, a pluggable transceiver is provided. The pluggable transceiver includes a housing having an input port and an output port and a data traffic optimization system. The data traffic optimization system includes at least one ingress data connector coupled with the input port and configured to communicatively couple to a network interface and to receive inbound data from the network interface, at least one egress data connector coupled with the output port and configured to communicatively couple to the network interface and to transmit outbound data to the network interface, control circuitry coupled to the at least one ingress data connector and the at least one egress data connector, a data traffic handler at least one of executable and controllable by the control circuitry and configured to receive the inbound data via the at least one ingress data connector and to generate, based on the inbound data, at least one classification of at least one data path traversing the network interface, a congestion window handler at least one of executable and controllable by the control circuitry and configured to control, based on at least one parameter, transmission of the outbound data via the at least one egress data connector, and a controller block at least one of executable and controllable by the control circuitry and configured to receive the at least one classification from the data traffic handler, to identify the at least one parameter based on the at least one classification, and to output the at least one parameter to the congestion window handler.

The pluggable transceiver may further include a length of cable having an end coupled to one of the input port and output port.

In another example, an active optical cable is provided. The active cable includes a data optimization system. The data traffic optimization system includes at least one ingress data connector coupled with the input port and configured to communicatively couple to a network interface and to receive inbound data from the network interface, at least one egress data connector coupled with the output port and configured to communicatively couple to the network interface and to transmit outbound data to the network interface, control circuitry coupled to the at least one ingress data connector and the at least one egress data connector, a data traffic handler at least one of executable and controllable by the control circuitry and configured to receive the inbound data via the at least one ingress data connector and to generate, based on the inbound data, at least one classification of at least one data path traversing the network interface, a congestion window handler at least one of executable and controllable by the control circuitry and configured to control, based on at least one parameter, transmission of the outbound data via the at least one egress data connector, and a controller block at least one of executable and controllable by the control circuitry and configured to receive the at least one classification from the data traffic handler, to identify the at least one parameter based on the at least one classification, and to output the at least one parameter to the congestion window handle. The active optical cable also includes a length of optical cable coupled to at least one of the at least one ingress data connector and the at least one egress data connector.

In another example, a direct attached cable is provided. The direct attached cable includes a data optimization system. The data traffic optimization system includes at least one ingress data connector coupled with the input port and configured to communicatively couple to a network interface and to receive inbound data from the network interface, at least one egress data connector coupled with the output port and configured to communicatively couple to the network interface and to transmit outbound data to the network interface, control circuitry coupled to the at least one ingress data connector and the at least one egress data connector, a data traffic handler at least one of executable and controllable by the control circuitry and configured to receive the inbound data via the at least one ingress data connector and to generate, based on the inbound data, at least one classification of at least one data path traversing the network interface, a congestion window handler at least one of executable and controllable by the control circuitry and configured to control, based on at least one parameter, transmission of the outbound data via the at least one egress data connector, and a controller block at least one of executable and controllable by the control circuitry and configured to receive the at least one classification from the data traffic handler, to identify the at least one parameter based on the at least one classification, and to output the at least one parameter to the congestion window handle. The direct attached cable also includes a length of cable coupled to at least one of the at least one ingress data connector and the at least one egress data connector.

In another example, a network interface card is provided. The network interface card includes a data traffic optimization system. The data traffic optimization system includes at least one ingress data connector coupled with the input port and configured to communicatively couple to a network interface and to receive inbound data from the network interface, at least one egress data connector coupled with the output port and configured to communicatively couple to the network interface and to transmit outbound data to the network interface, control circuitry coupled to the at least one ingress data connector and the at least one egress data connector, a data traffic handler at least one of executable and controllable by the control circuitry and configured to receive the inbound data via the at least one ingress data connector and to generate, based on the inbound data, at least one classification of at least one data path traversing the network interface, a congestion window handler at least one of executable and controllable by the control circuitry and configured to control, based on at least one parameter, transmission of the outbound data via the at least one egress data connector, and a controller block at least one of executable and controllable by the control circuitry and configured to receive the at least one classification from the data traffic handler, to identify the at least one parameter based on the at least one classification, and to output the at least one parameter to the congestion window handle.

In contrast to conventional approaches to congestion control, which tightly couple components that implement congestion control to particular physical devices, the data traffic optimization systems described herein are loosely coupled, both physically and logically, to other components of the network fabric. This loose coupling provides a host of advantages.

For instance, in some examples, the data traffic optimization system is not integral to the computing devices that originate data traffic on the network, but instead is implemented as a pluggable transceiver that may be positioned remotely from the originating devices. In other examples, the data traffic optimization system is implemented with a cable that connects a device to the network. Examples such as these, in which the data optimization system is implemented within an intermediate device, avoid the costs associated with installation, operation, upgrading, and maintenance of rack-based, dedicated hardware.

In other examples, one or more components of the data traffic optimization system are virtualized. Such virtualization enables commodity computing devices to be used for congestion control purposes. In addition, loosely coupled and/or virtualized components can be easily upgraded as improvements in congestion control technology emerge, thus avoiding technological obsolescence without requiring premature and expensive upgrades to existing network equipment.

Still other aspects, examples, and advantages are discussed in detail below. It is to be understood that both the foregoing information and the following detailed description are merely illustrative examples of various aspects and examples, and are intended to provide an overview or framework for understanding the nature and character of the claimed aspects and examples. Any example disclosed herein may be combined with any other example. References to “an example,” “some examples,” “other examples,” “an alternate example,” “various examples,” “one example,” “at least one example,” “this and other examples,” or the like are not necessarily mutually exclusive and are intended to indicate that a particular feature, structure, or characteristic described in connection with the example may be included in at least one example. The appearances of such terms herein are not necessarily all referring to the same example.

The phraseology and terminology used herein is for the purpose of description and should not be regarded as limiting. Any references to examples, components, elements, or acts of the systems and methods herein referred to in the singular may also embrace examples including a plurality, and any references in plural to any example, component, element or act herein may also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of any particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure.

FIG. 1 is a block diagram illustrating components of a data traffic optimization system in accordance with an example.

FIG. 2 is a flow diagram illustrating a data traffic optimization process in accordance with an example.

FIG. 3 is a schematic illustrating a data traffic optimization system integrated in a pluggable transceiver in accordance with an example.

FIG. 4 is a block diagram illustrating a data traffic optimization system integrated in directed attached cable (DAC) in accordance with an example.

FIG. 5 is a block diagram illustrating a data traffic optimization system integrated in a server in accordance with an example.

FIG. 6 is a block diagram illustrating a data traffic optimization system integrated in a network interface card (NIC) in accordance with an example.

FIG. 7 is a block diagram illustrating a data traffic optimization system integrated in an edge server in accordance with an example.

FIG. 8 is a block diagram illustrating multiple data traffic optimization systems integrated in multiple edge servers in accordance with an example.

### DETAILED DESCRIPTION

Data traffic optimization systems described herein are configured to monitor conditions of a network and to dynamically manage congestion control within the network. These monitoring and congestion control activities may be executed, for example, at the transport layer 4 of the Open System Interconnection (OSI) model. In execution, some of these data traffic optimization systems analyze network performance measures to estimate the available bandwidth and current latency of the network. Based on these estimates, the data traffic optimization system assigns values to one or more congestion control parameters. The values assigned to these congestion control parameters configure congestion control, as implemented by the data traffic optimization system, to current network conditions.

The available bandwidth and current latency of the network may be affected by various permanent and transient factors. These factors include as the capacity of the physical layer of the network and the amount of data traffic supported by the network. For example, the network's physical layer may be made up of wired connections, wireless connections, or a combination of the two (i.e., a hybrid physical layer). In general, wired connections tend to have greater bandwidth and lesser latency than wireless connections. Consequently, transport layer connections (e.g., transmission control protocol (TCP) connections) running over a physical layer with more wired connections tends to perform better than a transport layer connection running over a physical layer with more wireless connections.

The factors that affect the available bandwidth and current latency of the network also include the amount of data traffic supported by the network. For example, latency sensitive applications (e.g., video and/or audio streaming application) may consume substantial bandwidth and increase current latency depending on the amount of data transmitted and received within the transport layer connections supporting these applications. Conversely, latency insensitive applications (e.g. email) may consume less bandwidth and have little effect on current latency.

In some examples, to estimate the available bandwidth and current latency of the network, the data traffic optimization system is configured to analyze network performance measures, such as round trip time (RTT), packet drops, and number in-flight packets. To determine these network performance measures, the data traffic optimization system may actively transmit packets and receive acknowledgments via the network. Alternatively or additionally, the data traffic optimization system may passively monitor packets transmitted and received by other computing devices on the network. In some examples, these packets are TCP packets transmitted and received within a TCP connection between computing devices connected to the network.

In some examples, the data traffic optimization system is configured to implement congestion control within the network by implementing congestion control for transport layer connections, such as TCP connections. When executing according to this configuration, the data traffic optimization system maintains a cross-reference that associates network conditions (as may be expressed by network performance measures and/or types of data traffic traversing the network) with values of congestion control parameters. In these examples, the data traffic optimization system identifies parameter values to be used in controlling congestion for a transport layer connection by looking up, in the cross-reference, parameter values associated with current network conditions. Once identified, these parameter values are used to control transmission of data traffic by the transport layer connection, thereby controlling network congestion.

### Data Traffic Optimization System

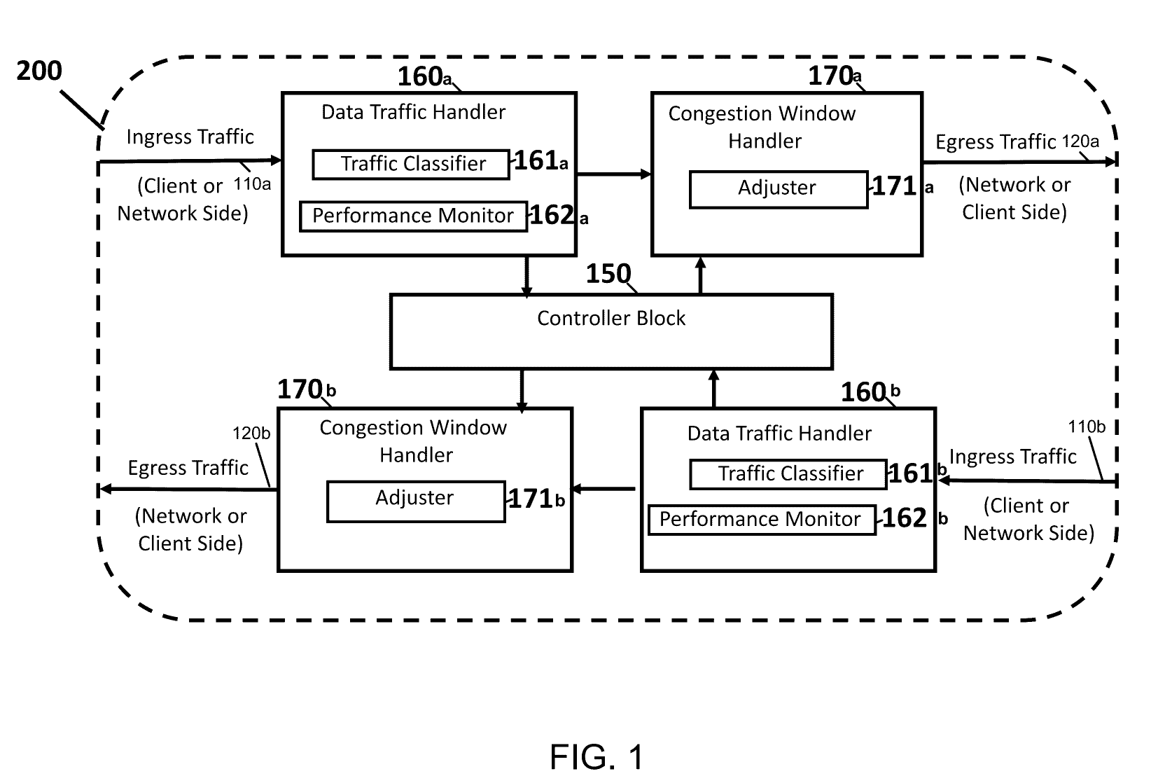

FIG. 1 illustrates one example of a data traffic optimization system 200 in accordance with some examples. The data traffic optimization system 200 is configured to interface with data traffic to intercept, process, and optimize data streams while remaining transparent to network traffic that is not related to optimization or not required by the data traffic optimization system 200. The data traffic optimization system 200 is configured to intercept data traffic to monitor several attributes of the data traffic. Examples of these attributes include traffic type, performance metrics, source and destination data, and user specific information that can be included with the traffic for the purpose of identification, user specific features, and security.

Further, the data traffic optimization system 200 can take actions based on the data traffic type, and/or information embedded in the said data traffic, and also any external input whether the input is physical or logical in form, or self-generated input by the controller complex/control circuitry itself such as timers which the user may enable or disable locally or remotely.

As described further below, in intercepting the data stream, the data traffic optimization system 200 identifies the traffic type as video, audio, or another type, monitors applicable attributes relevant for each data type and manipulates performance enhancing attributes that result in higher bandwidth utilization efficiency, higher throughput, and better performance in real time. In one example, this can be accomplished by dynamically increasing and decreasing the congestion window size and/or adjusting transmit and retransmit timing based on custom traffic optimization processes. These custom optimization processes may operate differently than standard TCP server stack congestion avoidance processes, such as Westwood, TCP Cubic, TCP Reno, which include various aspects of an additive increase/multiplicative decrease (AIMD) scheme with other schemes such as slow-start to achieve congestion avoidance. The custom traffic optimization process may be based on real time performance attributes such as jitter, in addition to delay, loss packets, or out of sequence errors. In this way, the data traffic optimization system 200 may optimize operation of a standard TCP software stack running on the server with connections to networking equipment particularly suitable for video and streaming video data traffic.

The data traffic optimization system 200 may be implemented using a wide variety of control circuitry. For instance, in some examples, the data traffic optimization system 200 is implemented as a set of instructions that are executable by at least one processor (e.g., a general purpose processor, controller, microprocessor, and/or microcontroller). In these examples, the instructions that comprise the data traffic optimization system 200 may be stored in volatile and/or non-volatile memory that is accessible by the processor and/or controller. In other examples, the data traffic optimization system 200 is implemented as one or more purpose built circuits (e.g., application specific integrated circuits, field programmable gate arrays, and/or other specialized, integrated or discrete circuitry).

The data traffic optimization system 200 is not limited to wired (optical or electrical) networks and may also be applied to wireless networks where data traffic is running through free space, air, water, or any other media (or any other yet undefined medium or media). Similarly, the data traffic optimization system 200 is independent from the underlying logical computing technologies such as electrical, optical, quantum or any future technology without any limitation, meaning that any computing platform whether composed on hardware, software, firmware or a combination thereof can be employed to practice the examples disclosed herein.

As shown in FIG. 1, the data traffic optimization system 200 includes ingress data connectors 110a and 110b (collectively 110), egress data connectors 120a and 120b (collectively 120), data traffic handlers 160a and 160b (collectively 160), a congestion window handlers 170a and 170b (collectively 170), and a controller block 150. The data traffic handler 160a includes a traffic classifier 161a and a performance monitor 162a. The data traffic handler 160b includes a traffic classifier 161b and a performance monitor 162b. The congestion window handler 170a includes an adjuster 171a. The congestion window handler 170b includes an adjuster 171b. The adjusters 171a and 171b are collectively referred to as adjusters 171. The traffic classifiers 161a and 161b are collectively referred to herein as traffic classifiers 161. The performance monitors 162a and 162b be are collectively referred to herein as performance monitors 162. The data traffic handler 160, the congestion window handler 170, and the controller block 150 may be implemented using any of the control circuitry described above.

As depicted in FIG. 1, the ingress data connectors 110 are configured to receive data traffic (e.g., TCP packets) from a network or a client computing device and transmit the data traffic to the data traffic handlers 160. The egress data connectors 120 are configured to receive data traffic from the congestion window handler 170 and to transmit the data traffic to the network or the client computing device. The ingress data connectors 110 and the egress data connectors 120 may be fabricated using a variety of materials including optical fiber, copper wire, and/or conduits capable of propagating signals.

In some examples, the data traffic handlers 160 are configured to classify received, inbound data traffic and to dynamically sense or determine key performance measures of the inbound data traffic. In these examples, the data traffic handlers 160 are also configured to selectively transmit the inbound data traffic to either the controller block 150 or the congestion window handlers 170 for subsequent processing, depending on the classification of the data traffic and the values of the key performance measures.

When executing according to this configuration in at least one example, the traffic classifiers 161 detect and classify inbound data traffic as one or more types or categories. For example, the traffic classifiers 161 may classify the data traffic according to a latency sensitivity of the transport layer connection including the data traffic. Several methodologies may be employed to detect the traffic type, including but not limited to deep packet inspection (DPI), virtual local area network (Virtual LAN) tagging, source address of the packet, destination address of the packet, socket pair of a TCP connection, port number of a TCP session, internet protocol (IP) address of a networking equipment, MAC address of the port of an equipment on which the data traffic optimization system 200 is executing.

In at least one example, the traffic classifiers 161 classify data traffic conveying video and/or audio streams into a first category and data traffic conveying email data into a second category because transport layer connections conveying video and audio streams are more sensitive to increases in latency than transport layer connections conveying email data. In another example, the traffic classifiers 161 classify data traffic being transmitted along a data path including wired connections into a first category, classify data traffic being transmitted along a data path including wireless connections into a second category, and classify data traffic being transmitted along a data path including both wired and wireless connections into a third (hybrid) category. These data paths include a series of physical layer devices and connections that support transport layer connections (e.g., TCP connections) that convey data traffic in the form of packets between endpoints.

In some examples, the performance monitors 162 are configured to determine and monitor applicable attributes, such as key performance measures, relevant for each data traffic category or type. These key performance measures may include (e.g., packet loss, average packet delay, bandwidth-delay product, average round trip time (RTT), minimum RTT, and maximum RTT). Where one or more of the key performance measures transgresses one or more threshold values specific to each data traffic category (e.g., where the latency in a connection increases beyond a maximum upper bound), the performance monitors 162 provide the data traffic to the controller block 150 for subsequent processing. Where the key performance measures remain within the category specific thresholds, the performance monitors 162 provide the data traffic to the congestion window handlers 170 for subsequent processing.

In some examples, the performance monitors 162 are also configured to manipulate performance enhancing attributes that are used as inputs by the congestion window handlers 170, which are described further below. For instance, in one example, the performance monitors 162 are configured to calculate a number of virtual connections that may be used by the congestion window handlers 170 to determine the size of a congestion window to be used by packets included in the data traffic.

In some examples, the controller block 150 is configured to receive and process inbound data, key performance measures, and data traffic classification information from the data traffic handlers 160. In these examples, the controller block 150 is also configured to transmit values of congestion control parameters to the congestion window handlers 170.

In execution, the controller block 150 uses the key performance measures and the data traffic classification information to identify values of congestion control parameters that will improve performance of the congestion window handlers 170. For instance, in some examples the controller block 150 maintains a cross-reference that lists values of congestion control parameters associated with key performance measures and/or data traffic classifications. The values of the congestion control parameters may include, for example, a maximum congestion window size and an amount by which a congestion window may be incrementally adjusted. In these examples, the controller block 150 identifies parameter values to transmit to the congestion window handlers 170 by looking up, in the cross-reference, parameter values associated with the key performance measures and/or the data traffic classification. Next, the controller block 150 transmits the identified parameters to the congestion window handlers 170 for further processing.

In some examples, the controller block 150 is configured to operate in a pass-through mode in response to receiving a predefined control signal. When operating in the pass-through mode, the controller block 150 signals the data traffic handlers 160 and the congestion window handlers 170 to cease processing of inbound and outbound data traffic, other than receipt and transmission thereof, to enable the data traffic to quickly move unchanged through the data traffic optimization system 200. In various examples, the controller block 150 may be configured to receive the predefined control signal via an in-band communication channel, an out-of-band communication channel, or a combination of the two. The predefined control signal may be under the control of a user who has physical access to the data traffic optimization system 200 or who is located remotely from the data traffic optimization system 200. Additionally, the predefined control signal may be provided by a computer system distinct from the data traffic optimization system 200. The pass-through mode may be particularly useful in the event that the network equipment already features a similar optimization capability.

In some examples, the congestion window handlers 170 are configured to receive and process inbound data, inputs from the performance monitors 162, and values of congestion control parameters from the controller block 150. In these examples, the congestion window handlers 170 are also configured to control transmission of outbound data traffic via the egress data connectors 120.

In execution, the adjusters 171 determine a size of an appropriate congestion control window for the transport layer connection including the data traffic based on the inputs from the performance monitors 162 and the values of the congestion control parameters received from the controller block 150. In some examples, the adjusters 171 use default values where the inputs and/or congestion control parameters have not been supplied. In other examples, the adjusters 171 use override values in place of the inputs and/or congestion control parameters. The override values may be supplied by an entity external to the data traffic optimization system 200, such as a user or system distinct from the data traffic optimization system 200 (e.g., the user device 806 described further below).

The adjusters 171 next adjust the congestion window size of outbound packets to match the determined congestion control window. The adjusters 171 also transmit/retransmit the inbound data as outbound data via the egress data connectors 120. By dynamically increasing and decreasing the congestion window size and transmit and retransmit timing based on custom optimization processes, the congestion window handlers 170 better match congestion control functions to current conditions (e.g., hop count, network bandwidth, network latency, etc.) of the data path the packets are currently traversing.

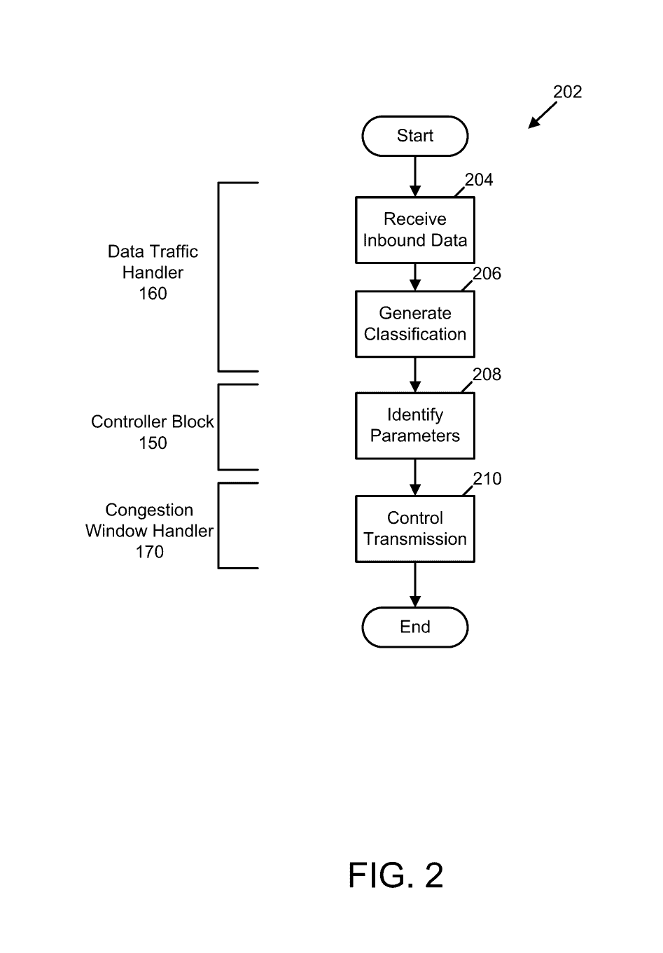

According to some examples, a data traffic optimization system (e.g., the data traffic optimization system 200) executes processes that monitor conditions of a network and dynamically manage congestion control within the network. FIG. 2 illustrates an optimization process 202 in accord with these examples. The optimization process 202 starts with act 204 in which data traffic handlers (e.g., the data traffic handlers 160) receive inbound data traffic from an ingress data connector (e.g., the ingress data connectors 110). In act 206, the data traffic handlers process the inbound data traffic to classify the data traffic and to determine key performance measures of the data traffic. Also, within the act 206, the data traffic handlers either transmit the inbound data traffic and the key performance measures to congestion window handlers (e.g., the congestion window handlers 170) or transmit the inbound data traffic, classification information for the data traffic, and key performance measures of the data traffic to a controller block (e.g., the controller block 150). In act 208, the controller block identifies values of one or more congestion control parameters based on the classification information and/or the key performance measures and provides the inbound data traffic and the values of the congestion control parameters to congestion window handlers (e.g., the congestion window handlers 170). In act 210, the congestion window handlers determine a congestion window size using the values of the congestion control parameters and/or the key performance measures. Also in the act 210, the congestion window handlers adjust the congestion window size stored in the inbound data traffic and transmit the inbound data traffic as outbound data traffic using an egress data connectors (e.g., the egress data connectors 120).

While the data traffic optimization system 200 described above focuses on optimization of data traffic at layer 4 of the OSI model, not all examples of the data traffic optimization system are limited to layer 4. The examples described herein are designed to maximize attributes such as bandwidth utilization efficiency, throughput, and performance including but not limited to real-time and near real-time applications requiring low latency, jitter, (examples such as video streaming, video conferencing). The data traffic optimization system optimizes in real-time during the streaming of a live or pre-recorded video or other type of data traffic or service, in an abstracted manner from the networks and networking equipment on which the said data traffic or service or services are running. Thus the data traffic optimization system provides a better end user experience as measured by better throughput and lower latency.

The data traffic optimization system may be implemented using purpose built hardware such as commodity optical transceivers, network interface cards (NICs), optical cables, or servers. The data traffic optimization system may be implemented via a virtual server or a plurality of virtual servers embodied within a Direct Attached Cables (DAC), Active Optical Cabling (AOC), or an optical NIC. The virtual server or the plurality of virtual servers can be embodied in pluggable optical or electrical transceivers, or hybrid optical and electrical devices such as NICs or optical acceleration modules in addition to DAC applications. The server or servers may be implemented as secure applications and accessible only via secure management channel or channels within the control circuitry, FPGA, ASIC, or the controller complex, ensuring security by disabling the possibility of hacking the server or servers directly via IP or any other means, as it is an TCP IP stack optimized in software, hardware, and/or firmware.

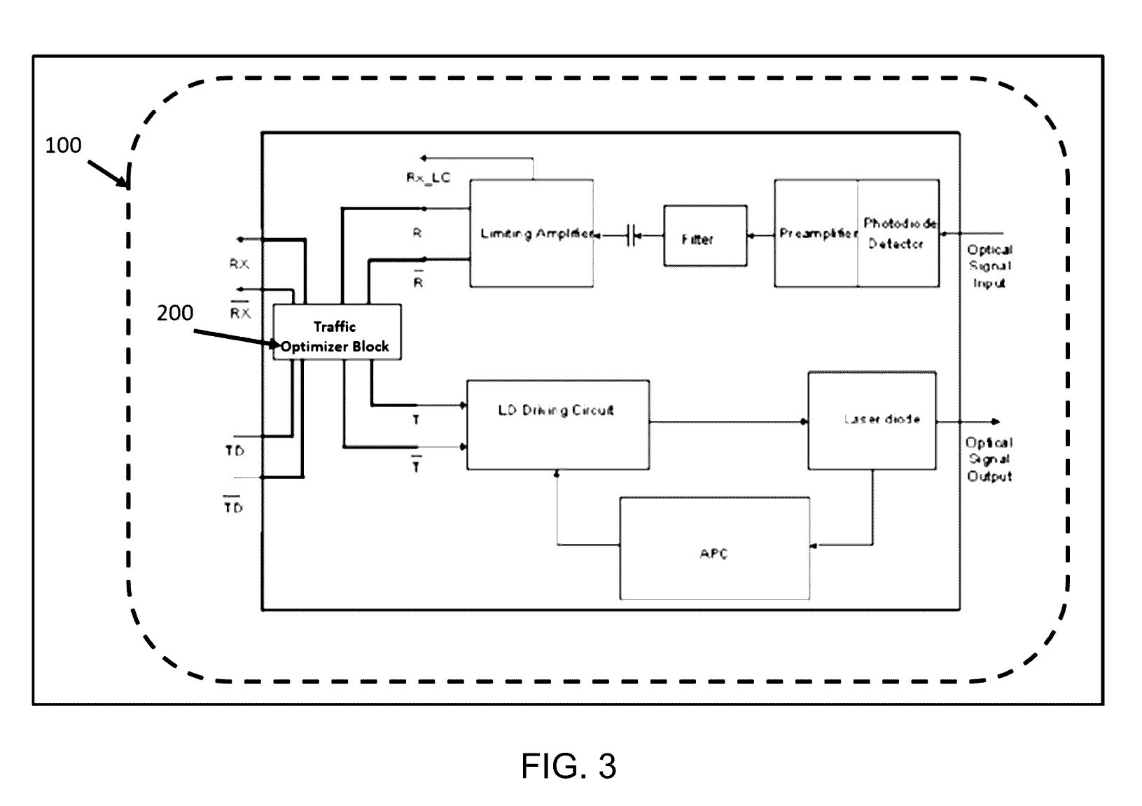

FIGS. 3-8 show data traffic optimization systems integrated within various parts of a network. As demonstrated by the variety of contexts illustrated in FIGS. 3-8, examples of the data traffic optimization system 200 have broad applicably. In any of these contexts, the data traffic optimization system 200 can be implemented as a part of an optical, copper, or other media that features any of the various interface types such as SFP, SFP+, XFP, X2, CFP, CFP2, CFP4, QSFP, QSFP28, PCIe, or any industry standard types.

FIG. 3 illustrates the data traffic optimization system 200 implemented within a pluggable transceiver 100. As shown in FIG. 3, the data traffic optimization system 200 is communicatively coupled (e.g., via the ingress data connectors 110 and the egress data connectors 120) to receive and transmit leads of the pluggable transceiver 100. In this example, the data traffic optimization system is positioned to monitor and control congestion in any data traffic communicated via a network interface coupled to the pluggable transceiver 100. The pluggable transceiver 100 may be a pluggable optical or electrical device such as an SFP or other variants of pluggable components, including but not limited to a universal serial bus (USB) stick, or a wireless dongle that can communicate with host equipment through wired, optical, or wireless media.

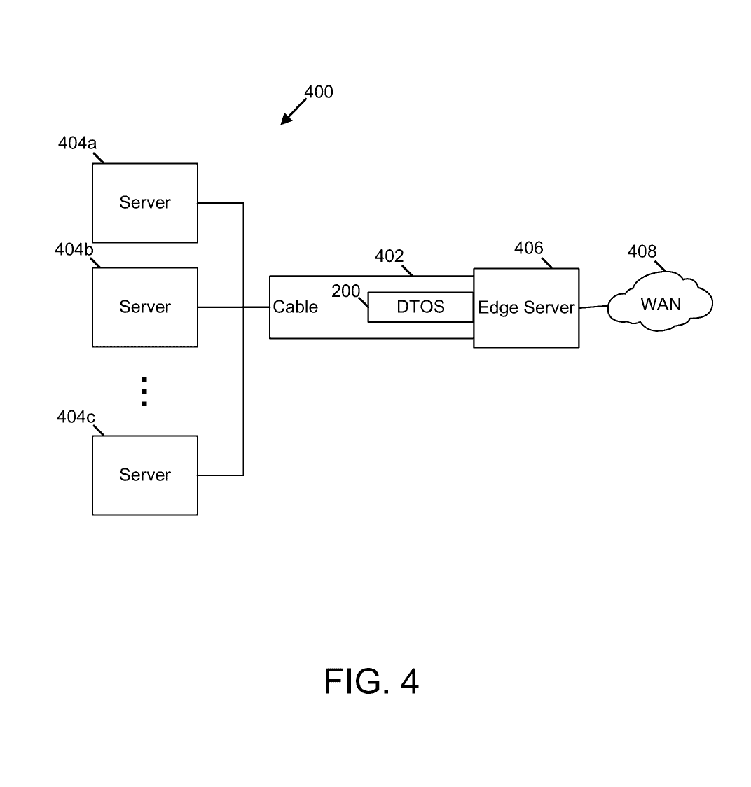

FIG. 4 illustrates a network 400 benefiting from inclusion of the data traffic optimization system 200 within a DAC 402. In some examples, the data traffic optimization system 200 is combined with the DAC 402 to form an external active cable assembly. In another example, the data traffic optimization system 200 may be disposed in one end of both ends of the DAC 402. The DAC 402 may be an active copper DAC and may be of a straight or a breakout type with a plurality of physical connections.

The network 400 includes servers 404a, 404b, through 404n (collectively 404) that are connected to edge server 406 via the DAC 402. The edge server 406 is connected to a wide area network (WAN) 408. As shown, the data traffic optimization system 200 is positioned to provide data traffic monitoring and congestion control to any packets transmitted within transport layer connections using data paths that involve the DAC 402 and edge server 406, such as transport layer connections in which an endpoint resides in the WAN 408.

In some examples, components of the data traffic optimization system are distributed and/or virtualized. For instance, in at least one example illustrated by FIG. 4, the controller block 150 is executed by remote control circuitry as a process on the edge server 406 and exchanges information with the data traffic handlers 160 and the congestion window handlers 170, which physically reside in the cable 402 as local control circuitry in the form of purpose built circuits. In another example, the controller block 150 is integral to and a subcomponent of the data traffic handlers 160. In another example, the controller block 150 executes under a Linux software kernel separate and distinct from the data traffic handlers 160 and accelerates data traffic after identification of the desired congestion control parameters. In other examples, the data traffic optimization system 200 is implemented as a set of virtualized processes by control circuitry residing in the cable 402. In these examples, each of the servers may have a separate virtualized data traffic optimization system 200 monitoring data traffic flowing through their transport layer connections and controlling congestion as described herein.

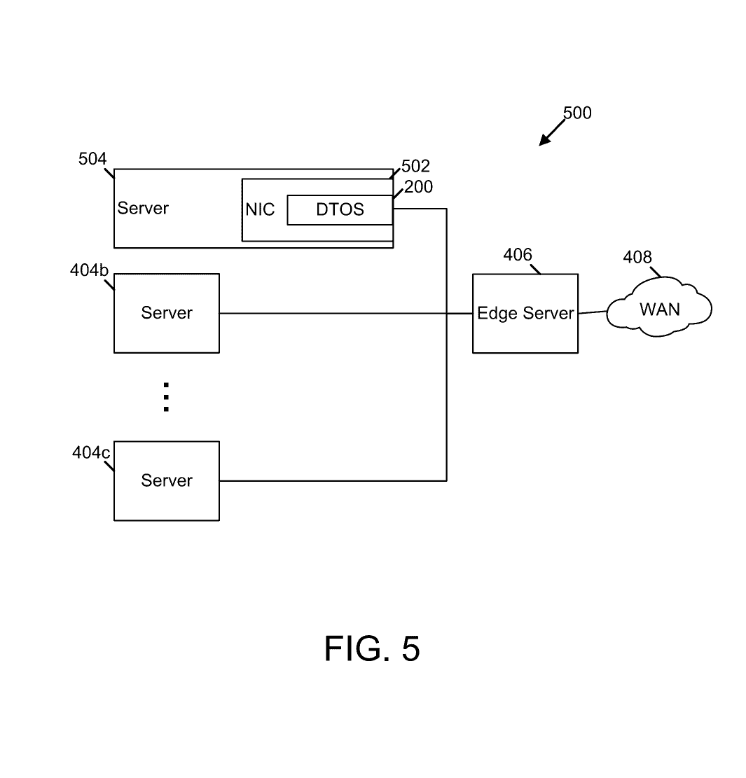

FIG. 5 illustrates a network 500 benefiting from inclusion of the data traffic optimization system 200 in a network interface card (NIC) 502 within a server 504. The server 504 is connected to the edge server 406 via the NIC 502 and other local area network equipment. The data traffic optimization system 200 is positioned to provide data traffic monitoring and congestion control to any packets transmitted within transport layer connections using data paths that involve the server 504.

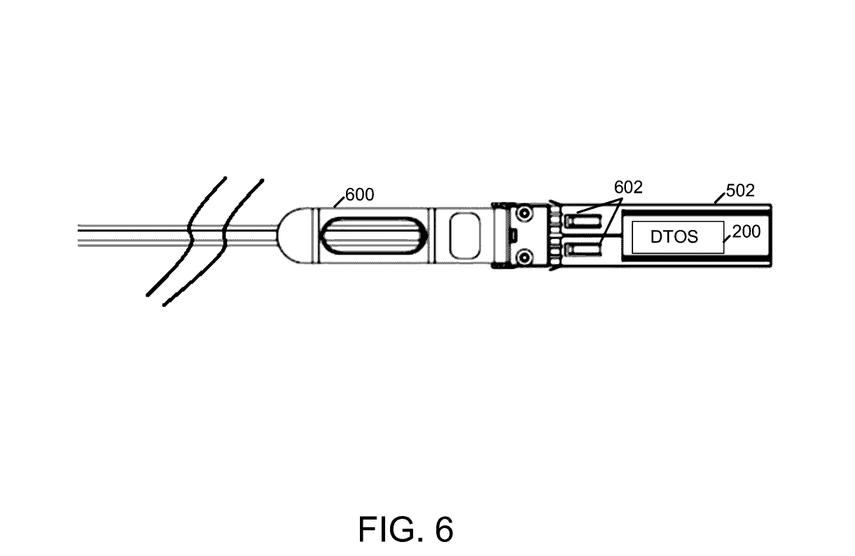

FIG. 6 is a more detailed view of the NIC 502 including the data traffic optimization system 200. FIG. 6 also illustrates a data cable 600 configured to communicatively couple to the NIC 502 via the network interface 602.

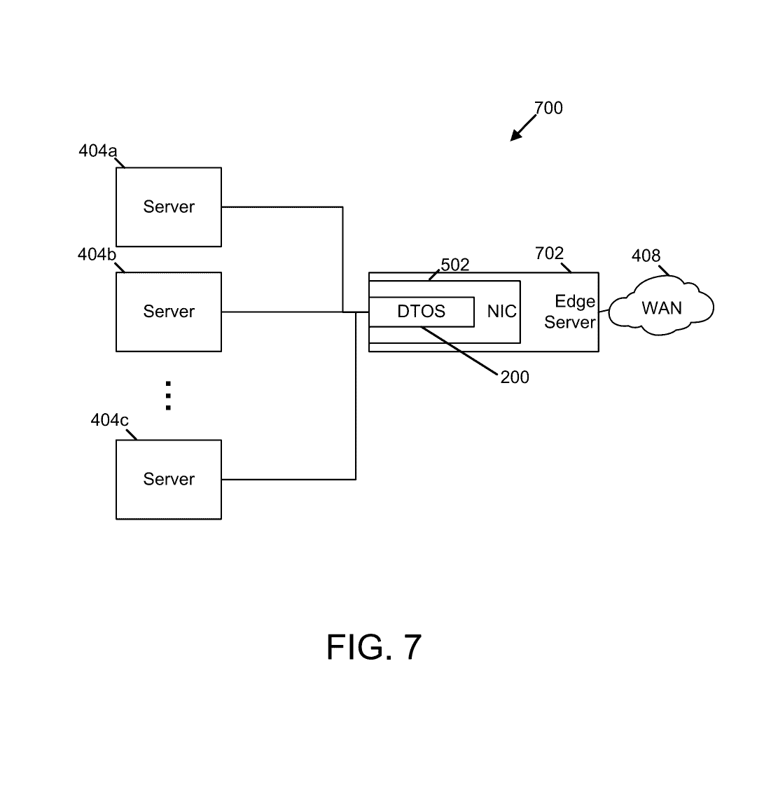

FIG. 7 illustrates another network 700 benefiting from inclusion of the data traffic optimization system 200 in the NIC 502 within an edge server 702. The network 700 includes servers 404 that are connected to edge server 702. The edge server 702 is connected to the WAN 408. As shown, the data traffic optimization system 200 is positioned to provide data traffic monitoring and congestion control to any packets transmitted within transport layer connections using data paths that involve the edge server 702, such as transport layer connections in which an endpoint resides in the WAN 408.

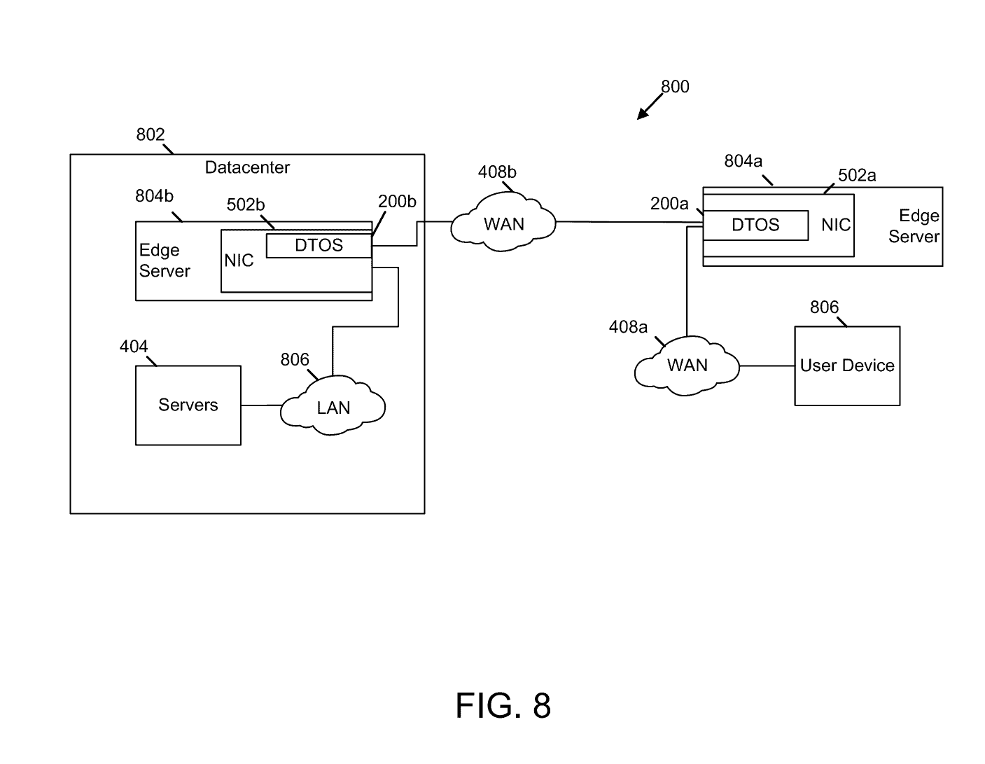

FIG. 8 illustrates another network 800 benefiting from inclusion of a first instance of the data traffic optimization system 200a in the NIC 502a within the edge server 804a and a second instance of the data traffic optimization system 200b in another NIC 502b within another edge server 804b. The network 800 includes a datacenter 802, WANs 408a and 408b, the edge server 804a and a user device 806. The datacenter 802 includes the edge server 804b, a local area network (LAN) 806 and servers 404. The user device 806 is connected to the edge server 804a via the WAN 408a. The edge server 804a is connected to the edge server 804b via the WAN 408b. The servers 404 are connected to the edge server 804b via the LAN 806.

As shown in FIG. 8, the data traffic optimization system 200b is positioned to provide data traffic monitoring and congestion control to any packets transmitted within transport layer connections using data paths that involve the WAN 408b, such as transport layer connections in which an endpoint is the user device 806. However, within the network 800, data paths that involve endpoints within the datacenter 802 are not processed by the data traffic optimization system 200b because their RTTs are low and monitoring and congestion control on these data paths would be superfluous activity. Also as shown, the data traffic optimization system 200a is positioned to provide data traffic monitoring and congestion control to any packets transmitted within transport layer connections using data paths that involve the edge server 810. These data paths will benefit from monitoring and congestion control because such paths will have longer RTTs.

The foregoing description of examples has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

1. A data traffic optimization system comprising:
at least one ingress data connector configured to communicatively couple to a network interface and to receive inbound data from the network interface;
at least one egress data connector configured to communicatively couple to the network interface and to transmit outbound data to the network interface;
control circuitry coupled to the at least one ingress data connector and the at least one egress data connector;
a data traffic handler at least one of executable and controllable by the control circuitry and configured to receive the inbound data via the at least one ingress data connector and to generate, based on the inbound data, at least one classification of at least one data path traversing the network interface, the at least one classification indicating that data traffic in the data path is at least one of latency sensitive video, latency sensitive audio, and latency insensitive data;
a congestion window handler at least one of executable and controllable by the control circuitry and configured to control, based on at least one parameter, transmission of the outbound data via the at least one egress data connector; and
a controller block at least one of executable and controllable by the control circuitry and configured to receive the at least one classification from the data traffic handler, to identify the at least one parameter based on the at least one classification, and to output the at least one parameter to the congestion window handler.

2. The data traffic optimization system of claim 1, wherein the at least one data path supports a transmission control protocol connection comprising the data traffic.

3. The data traffic optimization system of claim 1, wherein the data traffic handler comprises:
a performance monitor configured to determine at least one characteristic of the at least one data path; and
a traffic classifier configured to identify the at least one classification based on the at least one characteristic.

4. The data traffic optimization system of claim 3, wherein the at least one characteristic comprises at least one of a measurement of latency of the at least one data path and a measurement of bandwidth of a network supporting the at least one data path.

5. The data traffic optimization system of claim 4, wherein the measurement of bandwidth is based on a number of packets dropped from the data path.

6. The data traffic optimization system of claim 1, wherein the controller block is configured to identify the at least one parameter within a cross-reference listing one or more classifications corresponding to one or more parameters.

7. The data traffic optimization system of claim 6, wherein the at least one parameter comprises at least one of a maximum congestion window and congestion window adjustment amount.

8. The data traffic optimization system of claim 1, wherein the control circuitry comprises local control circuitry and remote control circuitry distinct from the local control circuitry and configured to communicate with the local control circuitry via the network interface, the data traffic handler is at least one of executable and controllable by the local control circuitry and is further configured to transmit the at least one classification to the controller block via the network interface, the congestion window handler is at least one of executable and controllable by the local control circuitry, the controller block is at least one of executable and controllable by the remote control circuitry, and the controller block is further configured to transmit the at least one parameter to the congestion window handler via a remote network interface coupled to the remote control circuitry.

9. The data traffic optimization system of claim 8, wherein the congestion window handler is configured to assign at least one default value to the at least one parameter prior to transmitting the at least one classification to the controller block.

10. The data traffic optimization system of claim 1, wherein the controller block is further configured to:
receive at least one override value for the at least one parameter;
change at least one value of the at least one parameter to the at least one override value; and
output the at least one parameter to the congestion window handler.

11. The data traffic optimization system of claim 1, wherein the at least one ingress data connector comprises a plurality of ingress data connectors and the at least one egress data connector comprises a plurality of egress data connectors.

12. The data traffic optimization system of claim 1, wherein the control circuitry comprises at least one processor and at least one data storage medium storing executable instructions encoded to instruct the at least one processor to implement the data traffic handler, the congestion window handler, and the controller block.

13. The data traffic optimization system of claim 12, wherein executable instructions are encoded to instruct the at least one processor to implement at least one virtual data traffic optimization system including a plurality of virtual data traffic handlers including the data traffic handler, a plurality of virtual congestion window handlers including the congestion window handler, and a plurality of virtual controller blocks including the controller block.

14. The data traffic optimization system of claim 1, wherein the control circuitry comprises purpose built circuitry.

15. The data traffic optimization system of claim 14, wherein the purpose built circuitry comprises at least one of an application specific integrated circuit, a field programmable gate array, and discrete circuitry.

16. The data traffic optimization system of claim 1, wherein the control circuitry comprises a plurality of purpose built circuits, the data traffic handler is implemented as a first purpose built circuit of the plurality of purpose built circuits, the congestion window handler is implemented as a second purpose built circuit of the plurality of purpose built circuits, and the controller block is implemented as a third purpose built circuit of the plurality of purpose built circuits.

17. A method of processing data traffic by a data traffic optimization system, the method comprising:
receiving inbound data via at least one ingress data connector;
generating, based on the inbound data, at least one classification of at least one data path on a network, the at least one classification indicating that data traffic in the data path is at least one of latency sensitive video, latency sensitive audio, and latency insensitive data;
identifying at least one parameter based on the at least one classification; and
controlling, based on the at least one parameter, transmission of outbound data via at least one egress data connector.

18. The method of claim 17, further comprising:
determining at least one characteristic of the at least one data path; and
identifying the at least one classification based on the at least one characteristic.

19. The method of claim 18, wherein determining the at least one characteristic comprises calculating at least one of a measurement of latency of the at least one data path and a measurement of bandwidth of the network supporting the at least one data path.

20. The method of claim 19, wherein calculating the measurement of bandwidth comprises identifying a number of packets dropped from the data path.

21. A pluggable transceiver comprising:
a housing having an input port and an output port; and
a data traffic optimization system comprising at least one ingress data connector coupled with the input port and configured to communicatively couple to a network interface and to receive inbound data from the network interface,
at least one egress data connector coupled with the output port and configured to communicatively couple to the network interface and to transmit outbound data to the network interface,
control circuitry coupled to the at least one ingress data connector and the at least one egress data connector,
a data traffic handler at least one of executable and controllable by the control circuitry and configured to receive the inbound data via the at least one ingress data connector and to generate, based on the inbound data, at least one classification of at least one data path traversing the network interface,
a congestion window handler at least one of executable and controllable by the control circuitry and configured to control, based on at least one parameter, transmission of the outbound data via the at least one egress data connector, and
a controller block at least one of executable and controllable by the control circuitry and configured to receive the at least one classification from the data traffic handler, to identify the at least one parameter based on the at least one classification, and to output the at least one parameter to the congestion window handler.

22. The pluggable transceiver of claim 21, further comprising a length of cable having an end coupled to one of the input port and the output port.

23. An active optical cable comprising:
a data traffic optimization system comprising at least one ingress data connector configured to communicatively couple to a network interface and to receive inbound data from the network interface,
at least one egress data connector configured to communicatively couple to the network interface and to transmit outbound data to the network interface,
control circuitry coupled to the at least one ingress data connector and the at least one egress data connector,
a data traffic handler at least one of executable and controllable by the control circuitry and configured to receive the inbound data via the at least one ingress data connector and to generate, based on the inbound data, at least one classification of at least one data path traversing the network interface,
a congestion window handler at least one of executable and controllable by the control circuitry and configured to control, based on at least one parameter, transmission of the outbound data via the at least one egress data connector, and
a controller block at least one of executable and controllable by the control circuitry and configured to receive the at least one classification from the data traffic handler, to identify the at least one parameter based on the at least one classification, and to output the at least one parameter to the congestion window handler; and
a length of optical cable coupled to at least one of the at least one ingress data connector and the at least one egress data connector.

24. A direct attached cable comprising:
a data traffic optimization system comprising
at least one ingress data connector configured to communicatively couple to a network interface and to receive inbound data from the network interface,
at least one egress data connector configured to communicatively couple to the network interface and to transmit outbound data to the network interface,
control circuitry coupled to the at least one ingress data connector and the at least one egress data connector,
a data traffic handler at least one of executable and controllable by the control circuitry and configured to receive the inbound data via the at least one ingress data connector and to generate, based on the inbound data, at least one classification of at least one data path traversing the network interface,
a congestion window handler at least one of executable and controllable by the control circuitry and configured to control, based on at least one parameter, transmission of the outbound data via the at least one egress data connector, and
a controller block at least one of executable and controllable by the control circuitry and configured to receive the at least one classification from the data traffic handler, to identify the at least one parameter based on the at least one classification, and to output the at least one parameter to the congestion window handler; and
a length of cable coupled to at least one of the at least one ingress data connector and the at least one egress data connector.

25. A network interface card comprising:
a data traffic optimization system comprising at least one ingress data connector configured to communicatively couple to a network interface and to receive inbound data from the network interface,
at least one egress data connector configured to communicatively couple to the network interface and to transmit outbound data to the network interface,
control circuitry coupled to the at least one ingress data connector and the at least one egress data connector,
a data traffic handler at least one of executable and controllable by the control circuitry and configured to receive the inbound data via the at least one ingress data connector and to generate, based on the inbound data, at least one classification of at least one data path traversing the network interface,
a congestion window handler at least one of executable and controllable by the control circuitry and configured to control, based on at least one parameter, transmission of the outbound data via the at least one egress data connector, and
a controller block at least one of executable and controllable by the control circuitry and configured to receive the at least one classification from the data traffic handler, to identify the at least one parameter based on the at least one classification, and to output the at least one parameter to the congestion window handler.
